(19) United States
(12) Patent Application Publication
(10) Pub. No.: US 2025/0030449 A1
(43) Pub. Date: Jan. 23, 2025

(54) A SUCCESSIVE INTERFERENCE CANCELLATION RECEIVER FOR LINE-OF-SIGHT MULTIPLE-INPUT MULTIPLE-OUTPUT RECEIVERS

(71) Applicant: Telefonaktiebolaget LM Ericsson (publ), Stockholm (SE)

(72) Inventors: Cristian CZEGLEDI, Göteborg (SE); Lei BAO, Göteborg (SE); Sinh NGUYEN, Göteborg (SE); Magnus NILSSON, Kungsbacka (SE)

(21) Appl. No.: 18/708,904

(22) PCT Filed: Nov. 11, 2021
(86) PCT No.: PCT/SE2021/051130

§ 371 Date: May 9, 2024

(51) Int. Cl. H04B 1/7107; H04B 7/06

(52) U.S. Cl. CPC H04B 1/7107; H04B 7/0617

(57) ABSTRACT

A line-of-sight (LOS) multiple-input multiple-output (MIMO) microwave radio link receiver configured for successive interference cancelation (SIC) operation,
wherein the receiver includes a plurality of receiver input ports, where the receiver input ports are connected to a pre-detection network, configured to perform mutual MIMO interference cancellation for each receiver radio branch, and to output pre-detection signals for two or more symbol streams of the LOS-MIMO receiver,
where the pre-detection signals are fed in a SIC sequence to respective information symbol detectors of the symbol streams, where the output of each information symbol detector in the SIC sequence is arranged to be phase shifted and added to pre-detection signals yet to be fed to its respective information symbol detector,
where the output of the information symbol detectors of the symbol streams constitutes an output of the LOS MIMO microwave radio link receiver.

### TECHNICAL FIELD

The present disclosure relates to microwave radio link transceivers, and in particular to microwave radio link transceivers arranged for line-of-sight (LOS) multiple-input multiple-output (MIMO) operation. There are furthermore disclosed network nodes, computer programs, and computer program products for increasing the performance of radio link transceivers.

### BACKGROUND

A microwave radio link is a highly directive point-to-point radio link used, e.g., for backhauling traffic from a cellular access radio base station to a core network, or for fibre replacement in high speed data traffic applications. The radio links operate at high radio frequency carriers from about 3 GHz and upwards.

The spectral efficiency in terms of communicated information bits per second (bps) and Hz of a microwave radio link can be increased significantly if both the transmit side and the receive side comprises a plurality of spatially separated antennas, i.e., if the spatial dimension is exploited. Using MIMO operation, microwave radio links may reach spectral efficiencies beyond 40 bps/Hz.

A microwave radio link propagation channel is often clear LOS, i.e., the transmitter and receiver stations are in line-of-sight of each other, and there is very little, if any, multipath propagation. It was therefore long thought that this disqualified the microwave radio link transceivers from exploiting the spatial dimension in an efficient manner, due to lack of radio propagation channel diversity. However, it has been demonstrated that, by carefully positioning antennas in relation to each other, efficient MIMO operation can be enabled. This type of MIMO operation is referred to as LOS-MIMO operation, and is discussed, e.g., by P. Larsson in “Lattice array receiver and sender for spatially orthonormal MIMO communication,” 2005 IEEE 61st Vehicular Technology Conference, 2005, pp. 192-196 Vol. 1.

A problem encountered when implementing LOS-MIMO radio transceivers is the phase noise which arises when upconverting the transmit signal in frequency at the transmit side and when down converting the received signal at the receive side of the radio link. M. Sjodin, P. Ligander, L. Bao, and J. Hansryd discusses phase noise in LOS-MIMO systems in “A 40.2 bps/Hz Single Polarization 4×4 Line-of-Sight MIMO Link with Unsynchronized Oscillators,” in 2019 IEEE Radio and Wireless Symposium (RWS), 2019, pp. 1-3.

A number of solutions for mitigating the effects of phase noise in LOS-MIMO systems are known. For instance, U.S. Pat. No. 9,479,269B2 discusses a method which involves insertion of special pilot symbols in the transmitted signal.

However, despite the work done to-date, there is a continuing need for further improvements in microwave radio link transceiver design for LOS-MIMO operation, especially for LOS-MIMO deployments, which suffer from a performance penalty due to sub-optimal antenna placement.

### SUMMARY

It is an object of the present disclosure to provide techniques for implementing efficient high performance radio link transceivers adapted for LOS-MIMO operation. This object is obtained by a LOS-MIMO microwave radio link receiver configured for successive interference cancellation (SIC) operation. The receiver comprises a plurality of receiver input ports which are connected to a pre-detection network configured to perform MIMO processing by operating on the receiver radio branches, and to output pre-detection signals for two or more symbol streams of the LOS-MIMO receiver. The pre-detection signals are fed in a SIC sequence to respective information symbol detectors configured to detect the symbol streams, where the output of each information symbol detector in the SIC sequence (except for the last one) is arranged to be phase shifted and then amplitude and delay adjusted before adding them to pre-detection signals yet to be fed to its respective information symbol detector. The outputs of the information symbol detectors of the symbol streams constitute an output of the LOS MIMO microwave radio link receiver. This way efficient LOS-MIMO operation is enabled even when antenna deployment is sub-optimal, i.e., when the inter-antenna distances at the transmit side and at the receive side are non-ideal for a given carrier frequency and radio link distance. This is primarily achieved by the additional interference cancellation performed after the symbol detection, in the SIC sequence. The receiver is adaptive due to the pre-detection network which allows it to adjust efficiently to variation in the radio propagation channel between transmitter antennas and receiver antennas. The proposed technique is most advantageously used when transmit side oscillators of the LOS-MIMO microwave radio link are not perfectly synchronized. The SIC sequence ideally reflects detection error probability, i.e., such that high signal-to-noise ratio (SNR) streams are detected before low SNR streams, at least in terms of received energy per information bit to noise power (Eb/N0). This way, streams associated with low detection error probability are detected initially, and the output of the detection is then used to improve the detection performance of the following streams in the SIC sequence which would otherwise have been detected at higher detection error probability. Generally, the SIC sequence may be a pre-determined sequence or an adaptive sequence that can be adjusted in dependence of LOS-MIMO operating conditions.

According to aspects, the pre-detection network comprises a phase noise tracking system configured to compensate for differences in receiver phase in-between the receiver radio branches of the LOS-MIMO microwave radio link receiver. The phase noise tracking system allows for use of less advanced asynchronous oscillator structures at the receive end, which is an advantage. The phase noise tracking system also allows for operation at relatively high carrier frequencies, such as at 80 GHz or beyond. Thus, the present receiver enables communication at high carrier frequency, unlike conventional MIMO receivers designed for operation at lower carrier frequencies.

According to aspects, the phase noise tracking system is based on an error signal determined as a difference between the input and the corresponding output of an information symbol detector of the receiver radio branch. Thus an adaptive receiver is provided able to efficiently adapt to changes in the radio propagation environment, and which does not add significant computational complexity to the overall receiver architecture. The phase noise tracking system may also be based on a constant modulus algorithm (CMA), at least during an acquisition phase when the symbol detector error signal may not be available.

According to aspects, the pre-detection network comprises an amplitude adjustment system configured to compensate for differences in radio propagation channel gain and/or hardware impairments in-between a LOS-MIMO microwave radio link transmitter and the receiver radio branches. It is an advantage to separate the (potentially complex-valued) amplitude adjustment from the phase tracking system, since the amplitude adjustment system is preferably updated with smaller bandwidth, i.e., slower compared to the fast phase noise tracking system of the pre-detection network. The pre-detection network amplitude adjustment system is optionally based on a Q-matrix of a QR-factorization of an estimated LOS-MIMO radio channel propagation matrix H. The pre-detection network amplitude adjustment system may optionally also be based on an error signal determined as a difference between an input and the corresponding output of the information symbol detector of the receiver radio branch. This is a rather well known method for updating adaptive receivers, which can be implemented at reasonable computational load, and which often provides robust performance, which of course is an advantage. A well-known robust method, such as least-mean-squares (LMS), can be used for the update.

According to aspects, the output of each information symbol detector in the SIC sequence is phase shifted based on an error signal and added to a target pre-detection signal yet to be fed to its respective information symbol detector. The error signal is, e.g., determined as a difference between the input and the corresponding output of the information symbol detector corresponding to the target pre-detection signal. This part of the processing mitigates the drawback of sub-optimal antenna placement, and provides performance improvement to the overall LOS-MIMO system performance.

According to aspects, the output of each information symbol detector in the SIC sequence is amplitude adjusted based on an error signal and added to a target pre-detection signal yet to be fed to its respective information symbol detector, where the error signal is determined as a difference between input and corresponding output of the information symbol detector corresponding to the target pre-detection signal. The amplitude adjustment potentially provides a further increase in receiver performance, especially when the antenna deployment is sub-optimal for LOS-MIMO operation, i.e., when the inter-antenna geometry is not ideal considering the carrier frequency of the LOS-MIMO system and the hop distance. The output of each information symbol detector in the SIC sequence may for instance be amplitude adjusted based on an R-matrix of a QR-factorization of a LOS-MIMO radio channel propagation matrix H and added to a target pre-detection signal yet to be fed to its respective information symbol detector.

According to aspects, one of the receiver radio branches is arranged to receive radio signals having a first polarization, and where another of the receiver radio branches is arranged to receive radio signals having a second polarization different from the first polarization and preferably orthogonal to the first polarization. Thus, dual polarization operation is enabled, which is an advantage.

There is also disclosed herein methods, control units, circuits, network nodes, and computer program products associated with the above-mentioned advantages.

### BRIEF DESCRIPTION OF THE DRAWINGS

The present disclosure will now be described in more detail with reference to the appended drawings, where:

FIG. 1 shows an example communication network;

FIG. 2 schematically illustrates a 2×2 LOS-MIMO radio link;

FIG. 3 illustrates an example SIC-based LOS-MIMO receiver architecture;

FIG. 4 illustrates another example SIC-based LOS-MIMO receiver architecture;

FIG. 5 is a flow chart illustrating example methods;

FIGS. 6-7 schematically illustrate example network nodes.

FIG. 8 schematically illustrates processing circuitry; and

FIG. 9 shows a computer program product;

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

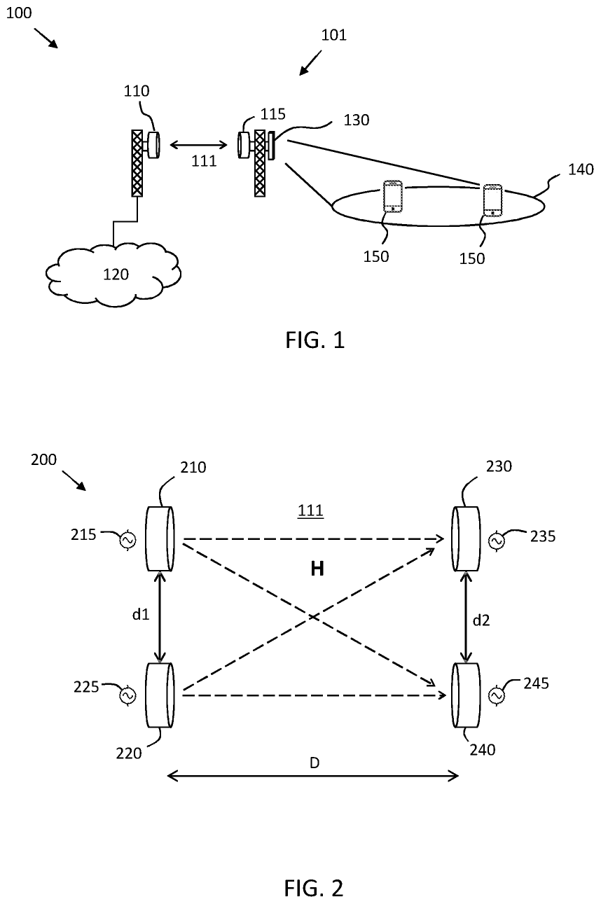

FIG. 1 illustrates an example communication system 100 comprising one or more radio base stations 130 configured to serve a number of wireless devices 150 comprised in a cellular coverage area 140. The communication system 100 may be a fourth generation (4G), fifth generation (5G) or even a sixth generation (6G) network defined by the third generation partnership program (3GPP), or some other type of communication network. It is appreciated that the techniques disclosed herein are not limited to any particular type of communication system but can be applied in most wireless systems comprising microwave radio links.

A microwave radio link 111 between a pair of microwave radio link transceivers 110, 115 is used to backhaul data traffic between the wireless devices 150 and a core network 120. As mentioned above, a microwave radio link transceiver is a radio transceiver operating at high carrier frequency, e.g., above 6 GHz or higher, and arranged with a highly directive antenna to provide a stable, high throughput, data connection between two fixed points. A microwave radio link is often referred to a point-to-point microwave radio link for these reasons. It is appreciated that the requirements in terms of error rates, packet loss, and the like are often much stricter for a backhaul link compared to a radio link between user equipment and a radio base station in the access network.

A microwave radio link transceiver may form part of a network node 101. The network node may also comprise other network devices, such as a one or more radio base stations, and/or one or more optical fibre transceivers.

The spectral efficiency (often given in terms of bps/Hz) of a microwave point-to-point radio link can be significantly increased if two or more antennas are used at the transmit side and two or more antennas are used at the receive side, as discussed, e.g., by P. Larsson in “Lattice array receiver and sender for spatially orthonormal MIMO communication,” 2005 IEEE 61st Vehicular Technology Conference, 2005, pp. 192-196 Vol. 1.

Herein, receiver performance is assumed to be defined in terms of detection error rate, i.e., a bit-error rate and/or a packet error rate. A high performing microwave radio link system has a high spectral efficiency and also a low or non-existent error rate.

The following mathematical notation will the used throughout this disclosure:
H: an M×N complex-valued propagation channel matrix
G: the rank of channel H such that G≤min(M, N)
N: number of transmit-side antennas
M: number of receive-side antennas
sₙ: modulated information symbol at n-th TX antenna, part of a symbol stream
nₘ: thermal noise at m-th RX antenna
rₘ: received information symbol at m-th RX antenna, part of a symbol stream
zₙ: equalizer output for the n-th TX information stream
xₙ: output after interference cancellation for the n-th TX information stream
hₘₙ: propagation channel coefficient between n-th TX and m-th RX antennas
θₙ^{t}: phase noise realization at the n-th TX antenna
θₘ^{r}: phase noise realization at the m-th RX antenna
φₙₘ: phase compensation in the equalizer
φ′ₙₘ: phase compensation in the successive interference cancellation
Q: G×M equalization matrix of complex equalizer gains
R: G×G equalization upper-triangular matrix of complex cancellation gains
E: G×M phasor matrix of phase adjustments
E′: G×G phasor upper triangular matrix of cancellation phase adjustments \hat{x} generally denotes an estimate of variable x, and \tilde{x} denotes an approximative representation of variable x, potentially comprising biases and the like. Further, E* denotes element-wise complex conjugate of the elements in matrix E, E^{H} denotes Hermitian transpose, and E^{T} denotes matrix transpose. An M×N matrix, in general, has M rows and N columns. It is appreciated that the dimensions of the different matrices are dependent on implementation. The skilled person realizes that the definitions of matrix dimensions for a given implementation must be adjusted so as to match throughout, i.e., an N×M matrix always multiplies an M×N matrix (or a transposed N×M matrix) and so on.

Both R and E′ can of course also be defined as lower triangular matrices instead, which then results in a different decoding order, but with the same technical effect.

FIG. 2 illustrates an example LOS-MIMO radio link 200 comprising transmitter antennas 210, 220 and receiver antennas 230, 240. The information symbols transmitted from the transmit antennas to the receive antennas may be quadrature amplitude modulated (QAM) symbols or some other type of information symbol, such as information symbols in an orthogonal frequency division multiplexed (OFDM) system. The transmitter here comprises two separate transmit side oscillators 215 and 225 for converting the signal to be transmitted from baseband up to the transmission frequency band, and the receive side two separate receive side oscillators 235 and 245 for converting the signal back to baseband again, or at least to some intermediate frequency (IF). Of course, the receiver can also be used with synchronized oscillators at any of the TX and/or RX side. However, the techniques discussed herein are most advantageously used when there is no synchronization between transmit side oscillators.

For a microwave radio link, the transmission frequency band is normally above 3 GHz, such as the E-band which is located at about 80 GHz. Even higher carrier frequencies are also possible, such as 120 GHz and even bands up to about 300 GHz have been considered. It is normally very difficult to distribute such high frequency signals between spatially separated antennas, which is why independent oscillators, or oscillators sharing a lower frequency reference signal (which is easier to distribute due to the lower frequency) is used. In FIG. 2, the transmit side antennas are separated by distance d1 while the receive side antennas are separated by distance d2. These distances are ideally configured as function of the link distance D and the carrier frequency to yield near-optimal communication conditions, as discussed by P. Larsson in “Lattice array receiver and sender for spatially orthonormal MIMO communication,” 2005 IEEE 61st Vehicular Technology Conference, 2005, pp. 192-196 Vol. 1.

An ideal oscillator generates a pure sine wave. In the frequency domain, this would be represented as a single pair of Dirac delta functions (positive and negative conjugates) at the oscillator's frequency; i.e., all the signal's power is at a single frequency. However, all real-world oscillators have phase modulated noise components. The phase noise components spread the power of a signal to adjacent frequencies, resulting in noise sidebands. Oscillator phase noise often includes low frequency flicker noise and may include white noise.

Consider the following noise-free signal:

$$s ( t ) = A cos ( 2 π f t )$$

where A is its amplitude, f its phase, and t represents time. Phase noise and/or an unknown frequency offset is added to this signal by adding a stochastic process represented by ϕ(t) to the signal as follows:

$${s}^{′} ( t ) = A cos ( 2 π f t + ϕ ( t ) )$$

Phase noise is typically expressed in units of dBc/Hz, which represents the noise power relative to the carrier contained in a 1 Hz bandwidth centered at a certain offset from the carrier. For example, a certain signal may have a phase noise of −80 dBc/Hz at an offset of 10 kHz and −95 dBc/Hz at an offset of 100 kHz. Phase noise can be measured and expressed as single-sideband or double-sideband values, although such considerations have no effect on the present disclosure.

The phasor representing the n-th transmit side oscillator phase is denoted e^{jϕ}^{ₙ}^{^{t}}, where it is understood that the phase ϕₙ^{t} is a function of time although this dependency has been left out for increased readability.

The transmitted signal passes between the N transmit antennas 210, 220 to the M receive antennas 230, 240 over a LOS channel modelled by a complex channel matrix H. The channel, generally, applies a relatively slowly time-varying complex gain in-between any two antennas. This complex gain represents a change in amplitude as well as a change in phase. H is the complex-valued channel propagation matrix, which e.g. can be written as

$$H = [ \begin{matrix}{h}_{11} & {h}_{12} & {h}_{13} & {h}_{14} \\ {h}_{21} & {h}_{22} & {h}_{23} & {h}_{24} \\ {h}_{31} & {h}_{32} & {h}_{33} & {h}_{34} \\ {h}_{41} & {h}_{42} & {h}_{43} & {h}_{44}\end{matrix} ]$$

for 4×4 spatial (single-polarized) MIMO channel, or

$$H = [ \begin{matrix}{h}_{11}^{VV} & {h}_{12}^{VV} & {h}_{11}^{VH} & {h}_{12}^{VH} \\ {h}_{21}^{V V} & {h}_{22}^{V V} & {h}_{21}^{V H} & {h}_{22}^{V H} \\ {h}_{11}^{H V} & {h}_{12}^{H V} & {h}_{11}^{H H} & {h}_{12}^{H H} \\ {h}_{21}^{HV} & {h}_{22}^{HV} & {h}_{21}^{HH} & {h}_{22}^{HH}\end{matrix} ]$$

for 4×4 spatial dual-polarized MIMO channel with vertical (V) and horizontal (H) polarization.

The received signal is down-converted in frequency to baseband using the M receive side oscillators 235, 245. The phasor representing the m-th receive side oscillator phase is denoted e^{jϕ}^{ₘ}^{^{r}}, where it is again understood that the phase ϕₘ^{r} is a function of time.

Note that some antennas on the transmit side and/or at the receive side may share a single oscillator, and some oscillators may share a reference frequency signal. Generally, the higher the frequency of the reference signal, the more correlated the phase noise processes at the two oscillators will be. Also, there may be more transmit side antennas and/or more receive side antennas than the number of symbol streams traversing the microwave radio link hop.

Additive noise {n₁, n₂, . . . , n_{M}} is also added at the receiver. Consequently, the received signal at one of the receive side antenna branches is given by

$${r}_{m} = {\sum }_{n = 1}^{N} {h}_{mn} {e}^{j ( {θ}_{n}^{t} + {θ}_{m}^{r} )} {s}_{n} + {n}_{m}$$

where nₘ may at least resemble additive white Gaussian noise (AWGN).

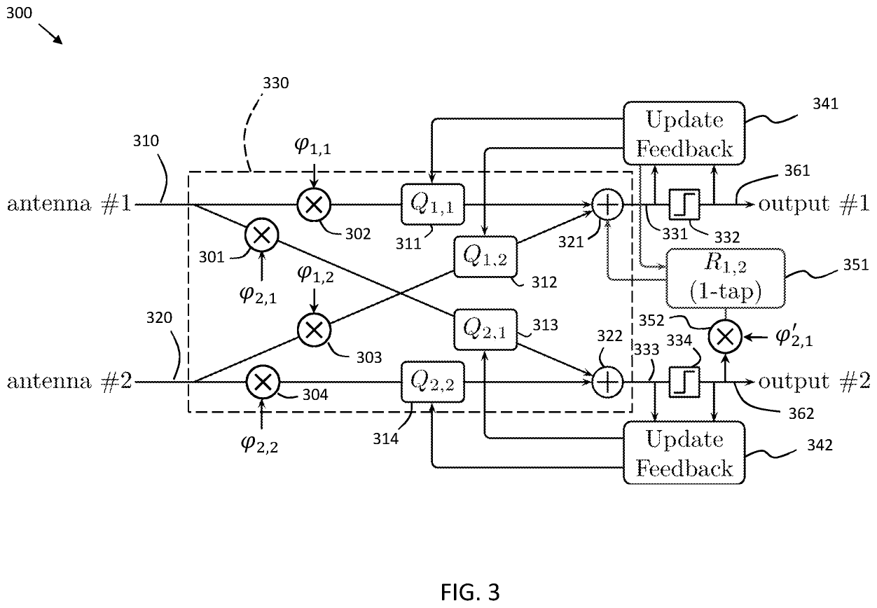

FIG. 3 shows a more detailed example of a LOS-MIMO receiver 300. The M signals received on the receive antenna branches are first samples by A/D converters (ADC) and then filtered by baseband (BB) filters. The filters signals are then input to a pre-detection network 330 which performs MIMO processing of the received radio signals on each receive branch, which may comprise MIMO interference cancellation and/or diversity combining operations in a known manner. Thus, the pre-detection network may perform a mix of interference cancellation and diversity combining, such as maximum ratio combining, on the signals received via the input ports.

The operations comprised in the pre-detection network 330 here includes the phase rotators 301, 302, 303, and 304, and the equalizing taps 311, 312, 313, and 314. The processed signals on the receive branches are added 321, 322, which removes a significant part of the MIMO interference on each symbol stream of the LOS-MIMO receiver. According to an example, the phase compensation values φ_{1,1}, φ_{1,2}, φ_{2,1}, φ_{2,2} as well as the equalizer tap values are determined based on correlation between an error signal 341, 342, although the feedback for the equalizer tap values is shown in the Figure. This error signal can, e.g., be determined as a difference before 331, 333 and after 361, 362 symbol detection 332, 334 as illustrated in FIG. 3. Many known ways exist for this operation, e.g., a least-mean-squares approach, or a constant modulus (CM) approach. Such methods for adaptive reception of a radio signal are known and will therefore not be discussed in more detail herein.

The MIMO equalizer taps may comprise a collection of finite impulse response (FIR) filters.

After equalization 311, 312, 313, 314, phase noise correction 301, 302, 303, 304, and signal combination 321, 322, the output 331, 333 can be written as:

$${z}_{n} = {\sum }_{m = 1}^{M} ( {Q}_{n m} {r}_{m} ) {e}^{j {φ}_{n m}} , for n = 1 , 2 , … ,$$

Where φₙₘ is a phase shifter compensating for the TX and RX phase noise. The above equations can be written in a more compact form as

$$z = ( Q ⊙ E ) {H}^{ϕ} s + \tilde{n}$$

where ⊙ denotes the Hadamard product operator and where

$$\tilde{n} = {[ {\tilde{n}}_{1} , {\tilde{n}}_{2} , … , {\tilde{n}}_{N} ]}^{T} ,$$

$${\tilde{n}}_{n} = {Σ}_{m = 1}^{M} {Q}_{n m} {n}_{n} {e}^{j {φ}_{n m}} ,$$

$$z = {[ {z}_{1} , {z}_{2} , … , {z}_{N} ]}^{T} ,$$

$$s = {[ {s}_{1} , {s}_{2} , … , {s}_{N} ]}^{T} ,$$

and
H^{ϕ} is the M×N matrix whose (m, n) element is hₘₙ^{ϕ}=hₘₙe^{j(θ}^{ₙ}^{^{t}}^{+θ}^{ₘ}^{^{r}}⁾.

It is known that sub-optimal antenna placement has a negative effect on LOS-MIMO system performance. To mitigate the effects of sub-optimal antenna placement, precoding can be used. Precoding involves pre-processing at the transmit side followed by corresponding processing on the receive side. One option is to base the pre-processing operation on a singular value decomposition (SVD) of the estimated channel matrix H. Another alternative is to base the preprocessing on a QR-decomposition of the estimated channel matrix H.

Y. Jiang, J. Li, and W. Hager discuss a receiver method for MIMO processing based on QR-decomposition in” Joint Transceiver Design for MIMO Communications Using Geometric Mean Decomposition”, IEEE transactions on signal processing, VOL. 53, NO. 10, October 2005.

The magnitude compensations Q_{1,1}, Q_{1,2}, Q_{2,1}, Q_{2,2} and the phase shifts φ_{1,1}, φ_{1,2}, φ_{2,1}, φ_{2,2} of the pre-detection network 330 can be seen as the Q-part of a QR-decomposition based receiver, or strictly speaking the inverse of the QR-decomposition, even though the receiver components are adaptively updated at the receive side, without knowledge of any pre-processing applied to the transmit side.

The output of the pre-detection network 330 in FIG. 3 is fed to a successive interference cancelation (SIC) structure, where the detector outputs estimating the transmitted information symbols is used to cancel interference from the other MIMO streams. Thus, the pre-detection signals 331, 333 are fed in a SIC sequence to respective information symbol detectors 332, 334 of the symbol streams, where the output of each information symbol detector in the SIC sequence is arranged to be phase shifted 352 and added to pre-detection signals yet to be fed to its respective information symbol detector. The SIC sequence ideally reflects detection error probability, such that high signal-to-noise ratio (SNR) streams are detected before low SNR streams, for instance in terms of received energy per bit in relation to noise power (Eb/N0) for the different streams. This means that a stream associated with low detection error probability is detected initially, and the output from this detection can then be used to reduce the detection error probability of some other stream which would otherwise have been associated with higher detection error probability. It is appreciated that a lower order modulation stream such as a quadrature phase shift keying (QPSK) stream carrying 2 bits per symbol may be associated with a higher SNR in terms of Eb/NO compared to a higher order stream such as a 16 quadrature amplitude modulation (QAM) stream carrying four bits per symbol, even if the total received signal power compared to the noise power (S/N) is higher for the 16-QAM stream. Other SIC sequences can of course be used, although this is the general principle. Generally, the SIC sequence may be a pre-determined sequence or an adaptive sequence that can be adjusted in dependence of LOS-MIMO operating conditions. It is appreciated that the methods disclosed herein are likely to result in measurable performance improvements even if an “optimal” SIC sequence is not used. For instance, it is often sufficient if a good enough stream is detected initially, followed by the other streams in approximate order of received signal quality. Thus, a SIC sequence is to be construed as a pre-determined or adaptive sequence ordering of the symbol streams according to some criterion, often based on signal-to-noise ratio (SNR) or signal-to-noise-and-interference ratio (SINR). The concept of a SIC sequence is to first detect the signal which is easiest to detect without error, often the one with the highest SNR or SINR, and then perform SIC interference cancellation using the detected symbol, as illustrated in FIG. 3, where output #2 is the first symbol stream in the SIC sequence.

The SIC structure optionally also comprises an amplitude adjustment 351, and both the phase shift φ′_{2,1} and the amplitude adjustment R₁₂ can be updated based on an error signal as in the pre-detection network 330. This amplitude adjustment may be a single tap structure or a tapped delay line structure which is then also able to handle delay variation. Alternatively, the phase compensation φ′_{2,1} can be determined directly from the respective compensations applied in the pre-detection network 330. The optional amplitude adjustment 351 may be real- or complex-valued and may comprise of a finite impulse response (FIR) filter, and my compensate for time delays between different TX branches.

There are at least as many symbol streams as there are receive branches, but there may be more receive branches than there are symbol streams, such as if some diversity reception is performed. Generally, there is one output for each symbol stream from the pre-detection network 330.

According to an example, the demodulators 332, 334 perform an optimization over the transmission symbol alphabet [symbol] , i.e.,

$${\hat{s}}_{n} = {arg min}_{{𝒮}_{k} ∈} \vert {x}_{n} - {𝒮}_{k} \vert$$

where [symbol] ={ [symbol] ₁, [symbol] ₂, . . . [symbol] _{L}} is the set of the 2^{L} possible transmitted information symbols, L is the modulation index, and

$${x}_{n} = {z}_{n} + {\sum }_{m = n + 1}^{N} ( {R}_{n m} {\hat{s}}_{m} ) {e}^{j {φ}_{n m}^{′}} , for n = 1 , 2 , …$$

When the equalizers and successive interference canceller converge, we have

$$( ( R ⊙ {E}^{′} ) ( Q ⊙ E ) ) {H}^{ϕ} = {I}_{N}$$

Where I_{N} denotes the N×N identity matrix. Here, the terms (R⊙E′) and (Q⊙E) could be obtained by applying the QR-decomposition on the instantaneous effective channel H^{ϕ}, including phase noise, where the first term is the inverse of the R-part and the second term is the inverse of the Q-part, respectively.

The SIC structure in FIG. 3 has a similar effect to that of applying the R-part of a QR-decomposition or modified QR-decomposition with the diagonal elements of R set to 1, based LOS-MIMO transceiver system. This is a significant advantage since it allows operation with sub-optimal antenna placement even if the transmit side and the receive side LOs are associated with at least partly uncorrelated phase noise processes.

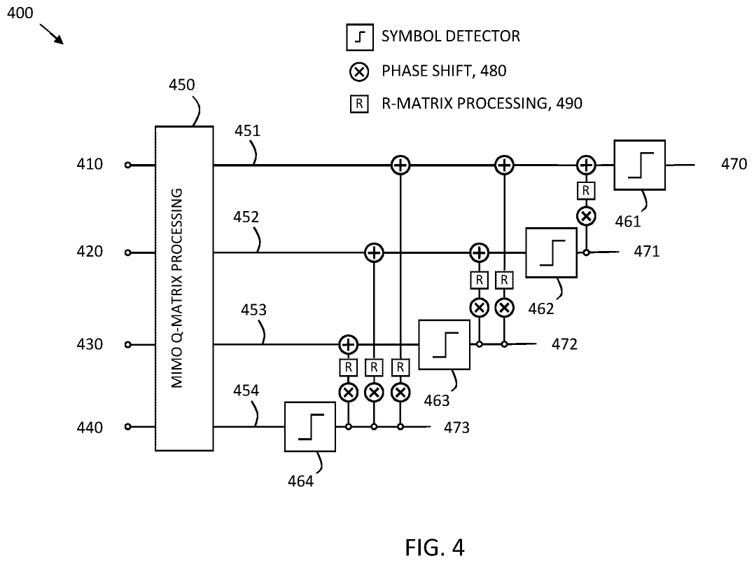

FIG. 4 illustrates another example 400 of the proposed LOS-MIMO receiver structure. This receiver structure instead has four receiver radio branches with respective receiver input ports 410, 420, 430, 440. Each receiver radio branch corresponds to a respective receive antenna of the LOS-MIMO system 400. The receiver input ports are connected to a pre-detection network 450 configured to perform mutual MIMO interference cancellation for each receiver radio branch, and to output pre-detection signals 451, 452, 453, 454 carrying four respective symbol streams. The pre-detection signals are fed in a SIC sequence to respective information symbol detectors 461, 462, 463, 464, where the output of each information symbol detector in the SIC sequence is arranged to be phase shifted 480 and added to pre-detection signals yet to be fed to its respective information symbol detector, as illustrated in FIG. 4. The LOS-MIMO receiver outputs the detected information symbols 470, 471, 472 and 473 as an output of the LOS-MIMO receiver 400. It is appreciated that suitable time delays are required in the receiver architecture. Such time delays are not shown in the example 400. The time delays are configured to compensate for variation in signal processing delay of the different branches in the LOS-MIMO receiver.

It is appreciated that a LOS-MIMO microwave radio link receiver 300, 400 such as those exemplified in FIG. 3 and in FIG. 4 may be configured to operate at two or more different polarizations. Thus, according to some aspects, at least one of the receiver radio branches is arranged to receive radio signals having a first polarization, and at least another of the receiver radio branches is arranged to receive radio signals having a second polarization different from the first polarization and preferably orthogonal to the first polarization.

To summarize, there is disclosed herein a LOS-MIMO microwave radio link receiver 300, 400 configured for SIC operation. The receiver 300, 400 comprises a plurality of receiver input ports 310, 320, 410, 420, 430, 440. In some systems, the receiver input ports correspond to respective receiver radio branches, where each receiver radio branch corresponds to a respective receive antenna of the LOS-MIMO system 300, 400.

The receiver input ports are connected to a pre-detection network 330, 450, configured to perform mutual MIMO interference cancellation for each receiver radio branch and/or diversity combining operations, and to output pre-detection signals 331, 333, 451, 452, 453, 454 for two or more symbol streams of the LOS-MIMO receiver. It is noted that, generally, there are at least as many symbol streams as there are receiver radio branches, but there can be more receiver radio branches than information streams also, e.g., in case there are more receive antennas than there are transmit antennas in the LOS-MIMO deployment. The pre-detection network 330, 450 normally comprises a phase noise tracking system 301, 302, 303, 304 configured to compensate for differences in receiver phase 235, 245 in-between the receiver radio branches.

This can, e.g., be realized by updating the phase compensation based on an error signal determined at the symbol detectors of the LOS-MIMO receiver as discussed above. There are many known ways in which to adaptively update phase trackers such as the phase trackers discussed above in connection to FIG. 3 and FIG. 4. Common to most phase tracking systems, and differential receiver phase tracking system in particular, is that they are updated at high bandwidth, i.e., relatively fast in comparison to the information symbol rate, in order to be able to follow rapidly changing phases at the receive oscillators. Any amplitude adjustment can be much slower, at least normally. The phase noise tracking system 301, 302, 303, 304 may for instance be based on an error signal determined as the difference between the input and the corresponding output of the information symbol detector of the receiver radio branch, e.g., according to the orthogonality principle or some other form of LMS processing. Alternatively, the phase noise tracking system 301, 302, 303, 304 can be based on a constant modulus algorithm (CMA), which can be suitable during an acquisition phase of the LOS-MIMO receiver. Methods for tracking phase noise are generally known and will therefore not be discussed in more detail herein.

The pre-detection network 330, 450 optionally also comprises an amplitude adjustment system 311, 312, 313, 314 configured to compensate for differences in radio propagation channel gain and/or hardware impairments in-between a LOS-MIMO microwave radio link transmitter and the receiver radio branches.

This amplitude compensation is advantageously updated at a smaller update rate or bandwidth compared to the phase tracking, which is an advantage since amplitude often changes faster than the phase of the LOs in the system. The pre-detection network 330, 450 amplitude adjustment system 311, 312, 313, 314 is preferably based on an error signal determined as a difference between the input and the corresponding output of the information symbol detector of the receiver radio branch. As discussed above, the pre-detection network 330, 450 amplitude adjustment system 311, 312, 313, 314 can be seen as being based on a Q-matrix of a QR-factorization of an estimated LOS-MIMO radio channel propagation matrix H.

The pre-detection signals 331, 333, 451, 452, 453, 454 are then fed in a SIC sequence to respective information symbol detectors 332, 334, 461, 462, 463, 464 of the symbol streams, where the output of each information symbol detector in the SIC sequence is arranged to be phase shifted 352, 480 and added to pre-detection signals yet to be fed to its respective information symbol detector. The outputs of the information symbol detectors of the symbol streams constitute an output 361, 362, 470, 471, 472,473 of the LOS MIMO microwave radio link receiver 300, 400.

According to some aspects, the output of each information symbol detector in the SIC sequence is phase shifted 352, 480 based on an error signal and added to a target pre-detection signal yet to be fed to its respective information symbol detector, where the error signal is determined as a difference between the input and the corresponding output of the information symbol detector corresponding to the target pre-detection signal. The output of each information symbol detector in the SIC sequence is optionally also amplitude adjusted 351, 490 based on the error signal and added to the target pre-detection signal yet to be fed to its respective information symbol detector, where the error signal is determined as a difference between the input and the corresponding output of the information symbol detector corresponding to the target pre-detection signal. According to an example, the output of each information symbol detector in the SIC sequence is amplitude adjusted 351, 490 based on an R-matrix of a QR-factorization of a LOS-MIMO radio channel propagation matrix H and added to a target pre-detection signal yet to be fed to its respective information symbol detector. The R-matrix can of course be a tapped delay line structure, such as an FIR filter structure.

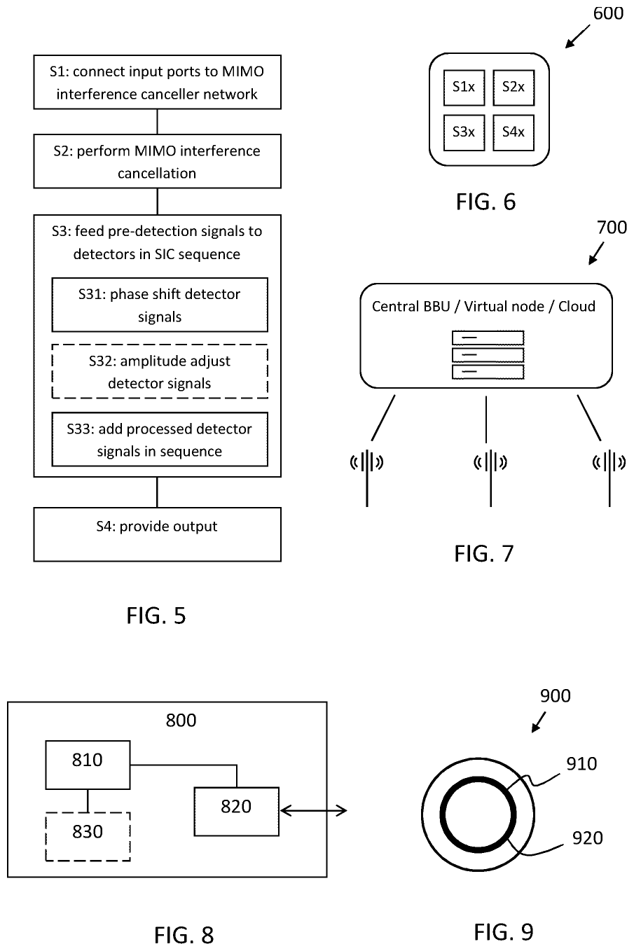

FIG. 5 is a flow chart illustrating a computer implemented method performed in a LOS-MIMO microwave radio link receiver 300, 400 configured for SIC operation, wherein the receiver 300, 400 comprises a plurality of receiver input ports 310, 320, 410, 420, 430, 440. The method comprises connecting S1 the receiver input ports to a pre-detection network 330, 450, performing S2 mutual MIMO interference cancellation for each receiver radio branch, and outputting a respective pre-detection signal 331, 333, 451, 452, 453, 454 for two or more symbol streams, feeding S3 the pre-detection signals 331, 333, 451, 452, 453, 454 in a SIC sequence to respective information symbol detectors 332, 334, 461, 462, 463, 464 of the symbol streams, where the output of each information symbol detector in the SIC sequence is phase shifted S31, 352, 480 and added S33 to pre-detection signals yet to be fed to its respective information symbol detector, and providing S4 the output of the information symbol detectors of the symbol streams as an output 361, 362, 470, 471, 472, 473 of the LOS MIMO microwave radio link receiver 300, 400.

According to some aspects, the method also comprises adjusting S32 an amplitude of the output of each information symbol detector in the SIC sequence based on an R-matrix of a QR-factorization of a LOS-MIMO radio channel propagation matrix H.

FIG. 6 schematically illustrates, in terms of a number of functional modules, the components of a control unit 600 for a LOS-MIMO microwave radio link receiver 300, 400 configured for SIC operation, wherein the receiver 300, 400 comprises a plurality of receiver input ports 310, 320, 410, 420, 430, 440. The control unit comprises a connecting module S1x configured to connect the receiver input ports to a pre-detection network 330, 450, an interference cancellation module S2x configured to perform mutual MIMO interference cancellation for each receiver radio branch, and outputting a respective pre-detection signal 331, 333, 451, 452, 453, 454 for two or more symbol streams, a SIC structure S3x configured to feed the pre-detection signals 331, 333, 451, 452, 453, 454 in a SIC sequence to respective information symbol detectors 332, 334, 461, 462, 463, 464 of the symbol streams, where the output of each information symbol detector in the SIC sequence is phase shifted S31, 352, 480 and added S33 to pre-detection signals yet to be fed to its respective information symbol detector, and an output module S4x configured to provide the output of the information symbol detectors of the symbol streams as an output 361, 362, 470, 471, 472, 473 of the LOS MIMO microwave radio link receiver 300, 400.

FIG. 7 illustrates various realizations 700 of the methods, devices and techniques discussed above. The methods and receivers discussed above may be implemented in a baseband processing unit (BBU) which could be deployed in a centralized manner or in a virtual node in the communications network 100. The split between the physical node and the centralized node can be on different levels, e.g. at I/Q samples level from the radio unit. Parts of the proposed methods may of course also be implemented on a remote server comprised in a cloud-based computing platform.

FIG. 8 schematically illustrates, in terms of a number of functional units, the general components of a control unit 800 according to embodiments of the discussions herein. Processing circuitry 810 is provided using any combination of one or more of a suitable central processing unit (CPU), multiprocessor, microcontroller, digital signal processor DSP, etc., capable of executing software instructions stored in a computer program product, e.g., in the form of a storage medium 830. The processing circuitry 810 may further be provided as at least one application specific integrated circuit ASIC, or field programmable gate array FPGA.

Particularly, the processing circuitry 810 is configured to cause the device 800 to perform a set of operations, or steps, such as the methods discussed in connection to FIG. 5 and the discussions above. For example, the storage medium 830 may store the set of operations, and the processing circuitry 810 may be configured to retrieve the set of operations from the storage medium 830 to cause the device to perform the set of operations. The set of operations may be provided as a set of executable instructions. Thus, the processing circuitry 810 is thereby arranged to execute methods as herein disclosed. In other words, there is shown a network node 800, comprising processing circuitry 810, a network interface 820 coupled to the processing circuitry 810 and a memory 830 coupled to the processing circuitry 810, wherein the memory comprises machine readable computer program instructions that, when executed by the processing circuitry, causes the network node to perform at least some of the techniques disclosed herein.

The storage medium 830 may also comprise persistent storage, which, for example, can be any single one or combination of magnetic memory, optical memory, solid state memory or even remotely mounted memory.

The device 800 may further comprise an interface 820 for communications with at least one external device. As such the interface 820 may comprise one or more transmitters and receivers, comprising analogue and digital components and a suitable number of ports for wireline or wireless communication.

The processing circuitry 810 controls the general operation of the device 800, e.g., by sending data and control signals to the interface 820 and the storage medium 830, by receiving data and reports from the interface 820, and by retrieving data and instructions from the storage medium 830. Other components, as well as the related functionality, of the control node are omitted in order not to obscure the concepts presented herein.

FIG. 9 illustrates a computer readable medium 910 carrying a computer program comprising program code means 920 for performing the methods illustrated in, e.g., FIG. 5, when said program product is run on a computer. The computer readable medium and the code means may together form a computer program product 900.

1. A line-of-sight, LOS, multiple-input multiple-output, MIMO, microwave radio link receiver configured for successive interference cancelation, SIC, operation, the LOS-MIMO microwave radio link receiver comprising:
a plurality of receiver input ports; and
a pre-detection network, connected to the receiver input ports, configured to perform mutual MIMO interference cancellation for each receiver radio branch, and to output pre-detection signals for two or more symbol streams of the LOS-MIMO receiver,
where the pre-detection signals are fed in a SIC sequence to respective information symbol detectors of the symbol streams, where the output of each information symbol detector in the SIC sequence is arranged to be phase shifted and added to pre-detection signals yet to be fed to its respective information symbol detector,
where the output of the information symbol detectors of the symbol streams constitutes an output of the LOS MIMO microwave radio link receiver.

2. The LOS-MIMO microwave radio link receiver according to claim 1, wherein the pre-detection network comprises a phase noise tracking system configured to compensate for differences in receiver phase in-between the receiver radio branches.

3. The LOS-MIMO microwave radio link receiver according to claim 1, wherein the phase noise tracking system is based on an error signal determined as a difference between the input and the corresponding output of the information symbol detector of the receiver radio branch.

4. The LOS-MIMO microwave radio link receiver according to claim 1, wherein the phase noise tracking system is based on a constant modulus algorithm, CMA.

5. The LOS-MIMO microwave radio link receiver according to claim 1, wherein the pre-detection network comprises an amplitude adjustment system configured to compensate for differences in radio propagation channel gain and/or hardware impairments in-between a LOS-MIMO microwave radio link transmitter and the receiver radio branches.

6. The LOS-MIMO microwave radio link receiver according to claim 5, wherein the pre-detection network amplitude adjustment system is based on a Q-matrix of a QR-factorization of an estimated LOS-MIMO radio channel propagation matrix H.

7. The LOS-MIMO microwave radio link receiver according to claim 5, wherein the pre-detection network amplitude adjustment system is based on an error signal determined as difference between the input and the corresponding output of the information symbol detector on each receiver radio branch.

8. The LOS-MIMO microwave radio link receiver according to claim 1, where the output of each information symbol detector in the SIC sequence is phase shifted based on an error signal and added to a target pre-detection signal yet to be fed to its respective information symbol detector, where the error signal is determined as a difference between the input and the corresponding output of the information symbol detector corresponding to the target pre-detection signal.

9. The LOS-MIMO microwave radio link receiver according to claim 1, where the output of each information symbol detector in the SIC sequence is amplitude adjusted and/or delay compensated based on an error signal and added to a target pre-detection signal yet to be fed to its respective information symbol detector, where the error signal is determined as a difference between the input and the corresponding output of the information symbol detector corresponding to the target pre-detection signal.

10. The LOS-MIMO microwave radio link receiver according to claim 1, where the output of each information symbol detector in the SIC sequence is amplitude adjusted based on an R-matrix of a QR-factorization of a LOS-MIMO radio channel propagation matrix H and added to a target pre-detection signal yet to be fed to its respective information symbol detector.

11. The LOS-MIMO microwave radio link receiver according to claim 1, where one of the receiver radio branches is arranged to receive radio signals having a first polarization, and where another of the receiver radio branches is arranged to receive radio signals having a second polarization different from the first polarization and preferably orthogonal to the first polarization.

12. A network node comprising a LOS-MIMO microwave radio link receiver configured for successive interference cancelation, SIC, operation, the network node comprising:
a plurality of receiver input ports; and
a pre-detection network, connected to the receiver input ports, configured to perform mutual MIMO interference cancellation for each receiver radio branch, and to output pre-detection signals—for two or more symbol streams of the LOS-MIMO receiver,
where the pre-detection signals are fed in a SIC sequence to respective information symbol detectors of the symbol streams, where the output of each information symbol detector in the SIC sequence is arranged to be phase shifted and added to pre-detection signals yet to be fed to its respective information symbol detector,
where the output of the information symbol detectors of the symbol streams constitutes an output of the LOS MIMO microwave radio link receiver.

13. A computer implemented method performed in a line-of-sight, LOS, multiple-input multiple-output, MIMO, microwave radio link receiver configured for successive interference cancelation, SIC, operation, wherein the receiver comprises a plurality of receiver input ports, the method comprising
connecting the receiver input ports to a pre-detection network;
performing mutual MIMO interference cancellation for each receiver radio branch, and outputting a respective pre-detection signal for two or more symbol streams;
feeding the pre-detection signals in a SIC sequence to respective information symbol detectors of the symbol streams, where the output of each information symbol detector in the SIC sequence is phase shifted and added to pre-detection signals yet to be fed to its respective information symbol detector; and
providing the output of the information symbol detectors of the symbol streams as an output of the LOS MIMO microwave radio link receiver.

14. The method according to claim 13, further comprising adjusting an amplitude of the output of each information symbol detector in the SIC sequence based on an R-matrix of a QR-factorization of a LOS-MIMO radio channel propagation matrix H.

15. (canceled)

16. The network node according to claim 12, wherein the pre-detection network comprises a phase noise tracking system configured to compensate for differences in receiver phase in-between the receiver radio branches.

17. The network node according to claim 12, wherein the phase noise tracking system is based on an error signal determined as a difference between the input and the corresponding output of the information symbol detector of the receiver radio branch.

18. The network node according to claim 12, wherein the phase noise tracking system is based on a constant modulus algorithm, CMA.

19. The network node according to claim 12, wherein the pre-detection network comprises an amplitude adjustment system configured to compensate for differences in radio propagation channel gain and/or hardware impairments in-between a LOS-MIMO microwave radio link transmitter and the receiver radio branches.

20. The network node according to claim 19, wherein the pre-detection network amplitude adjustment system is based on a Q-matrix of a QR-factorization of an estimated LOS-MIMO radio channel propagation matrix H.

21. The network node according to claim 19, wherein the pre-detection network amplitude adjustment system is based on an error signal determined as difference between the input and the corresponding output of the information symbol detector on each receiver radio branch.
